(19) United States
(12) Patent Application Publication
(10) Pub. No.: US 2023/0394090 A1
(43) Pub. Date: Dec. 7, 2023

(54) INFORMATION PROCESSING APPARATUS AND SELECTION SUPPORTING METHOD

(71) Applicant: Tokyo Electron Limited, Tokyo (JP)

(72) Inventors: Kakeru HIRATOKO, Iwate (JP); Ryota AOI, Hokkaido (JP); Takehiro KINOSHITA, Hokkaido (JP)

(21) Appl. No.: 18/201,869

(22) Filed: May 25, 2023

(30) Foreign Application Priority Data
Jun. 1, 2022 (JP) 2022-089910

(51) Int. Cl. G06F 16/9038; G06F 16/903

(52) U.S. Cl. CPC G06F 16/9038; G06F 16/90335; G06F 3/04842

(57) ABSTRACT

An information processing apparatus includes: a data acquisition unit that acquires specific data including the number of selections and selection date/time for each data selected for indicating the apparatus status, and a set of data and the number of selections of the set when multiple data are selected; a calculation unit that calculates a specific indicator by using at least one of the specific data; and a display controller that displays selection candidate data based on the specific indicator. The calculation unit executes at least one of: calculating a first indicator based on the number of selections for each data; calculating a second indicator based on selection date/time of each data; and calculating a third indicator based on the number of selections for each set of data. The display controller takes the first, second, and/or third indicators as the specific indicator, and displays the selection candidate data.

### CROSS-REFERENCE TO RELATED APPLICATIONS

This application is based on and claims priority from Japanese Patent Application No. 2022-089910, filed on Jun. 1, 2022, with the Japan Patent Office, the disclosure of which is incorporated herein in its entirety by reference.

### TECHNICAL FIELD

The present disclosure relates to an information processing apparatus and a selection supporting method.

### BACKGROUND

Japanese Patent Laid-Open Publication No. 2003-158049 proposes efficiently generating a process recipe of a substrate processing apparatus in a relatively short time, by considering the common parameters and intrinsic parameters of the substrate processing apparatus and the differences in apparatus configuration.

### SUMMARY

According to an aspect of the present disclosure, an information processing apparatus includes: a data acquisition unit that acquires specific data from a plurality of data managed by a substrate processing apparatus, the specific data including a number of selections and selection date/time for each data selected for indicating a status of the substrate processing apparatus, and a set of data and a number of selections of the set when multiple data are selected; a calculation unit that calculates a specific indicator indicating the status of the substrate processing apparatus by using at least one of the specific data; and a display control unit that displays selection candidate data extracted from the plurality of data based on the calculated specific indicator. The calculation unit executes at least one of following processes including: based on a number of selections of each data selected from the specific data, calculating a first indicator indicating a selection frequency of the data; based on a selection date/time of each data selected from the specific data, calculating a second indicator indicating a latest selection frequency of the data; and based on a number of selections for each set of data among multiple data selected from the specific data, calculating a third indicator indicating a selection frequency for each set of the data. The display control unit takes at least one of the calculated first, second, and third indicators as the specific indicator, and displays the selection candidate data based on the specific indicator.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating an example of a configuration of a substrate processing system according to an embodiment.

FIG. 2 is a view illustrating an example of a hardware configuration of an analysis device according to an embodiment.

FIG. 3 is a view illustrating an example of a functional configuration of the analysis device according to an embodiment.

FIG. 4 illustrates an example of a point table according to an embodiment.

FIG. 5 illustrates an example of a display of selection candidate data extracted by the analysis device.

FIG. 6 is a flowchart illustrating an example of a selection control process according to an embodiment.

FIG. 7 illustrates an example of a selection screen of multiple data managed by a substrate processing apparatus.

FIG. 8 illustrates an example of a selection screen (remote screen) of multiple data managed by the substrate processing apparatus.

FIG. 9 is a flowchart illustrating another example of the selection control process according to an embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented here.

Hereinafter, embodiments for implementing the present disclosure will be described with reference to the drawings. In the respective drawings, the same components may be denoted by the same reference numerals, and overlapping descriptions thereof may be omitted.

In the description herein, directions such as parallel, perpendicular, orthogonal, horizontal, vertical, up and down, and left and right allow some deviation that does not impair the effect of the embodiments. The shape of each part is not limited to a right-angled shape, but may be rounded in an arch shape. Terms such as parallel, perpendicular, orthogonal, horizontal, vertical, circular, and the same may include substantially parallel, substantially perpendicular, substantially orthogonal, substantially horizontal, substantially vertical, substantially circular, and substantially the same.

[Substrate Processing System]

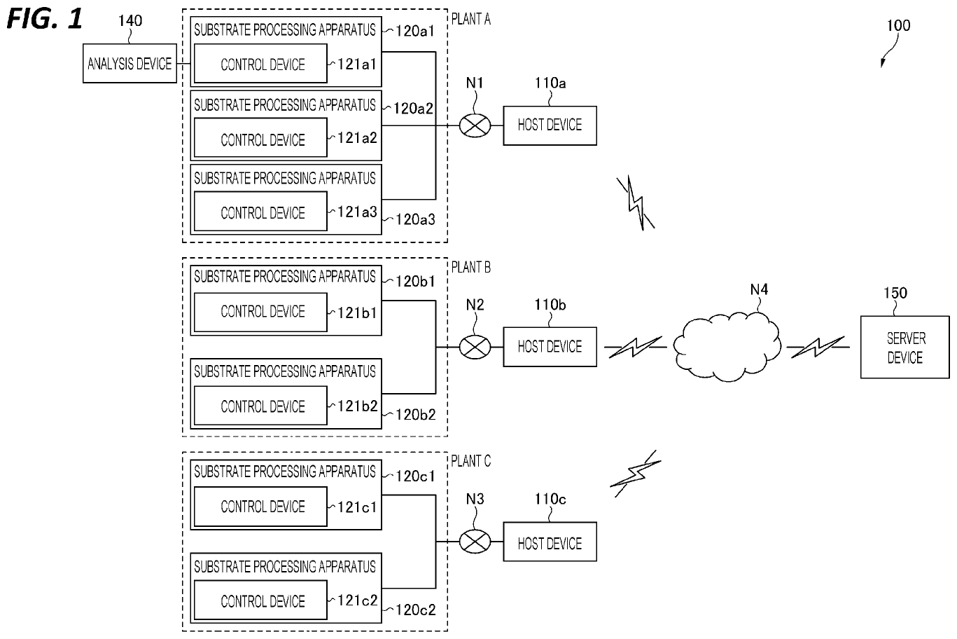

First, an example of a configuration of a substrate processing system according to an embodiment will be described. FIG. 1 is a view illustrating an example of a configuration of a substrate processing system 100 according to an embodiment. As illustrated in FIG. 1, the substrate processing system 100 includes substrate processing apparatuses 120a1 to 120a3 and control devices 121a1 to 121a3 in Plant “a.” The substrate processing apparatuses 120a1 to 120a3 and the control devices 121a1 to 121a3 are connected to each other by wire or wirelessly.

The substrate processing system 100 further includes substrate processing apparatuses 120b1 and 120b2 and control devices 121b1 and 121b2 in Plant “b.” The substrate processing apparatuses 120b1 and 120b2 and the control devices 121b1 and 121b2 are connected to each other by wire or wirelessly.

The substrate processing system 100 further includes substrate processing apparatuses 120c1 and 120c2 and control devices 121c1 and 121c2 in Plant “c.” The substrate processing apparatuses 120c1 and 120c2 and the control devices 121c1 and 121c2 are connected to each other by wire or wirelessly.

The substrate processing apparatuses 120a1 to 120a3, the substrate processing apparatuses 120b1 and 120b2, and the substrate processing apparatuses 120c1 and 120c2 are connected to host devices 110a, 110b, and 110c, respectively, via networks N1 to N3, respectively. Each substrate processing apparatus performs a substrate processing under the control of each control device based on an instruction from each corresponding host device 110a, 110b, or 110c. The host devices 110a, 110b, and 110c are connected to a server device 150 via a network N4 such as the Internet.

In the description herein below, the substrate processing apparatuses 120a1 to 120a3, 120b1, 120b2, 120c1, and 120c2 may be collectively referred to as a substrate processing apparatus 120. The control devices 121a1 to 121a3, 121b1, 121b2, 121c1, and 121c2 may be collectively referred to as a control device 121. The host devices 110a, 110b, and 110c may be collectively referred to as a host device 110.

Each substrate processing apparatus 120 manages and stores a plurality of data, which includes process condition data, sensor data, and measurement data obtained from measuring process results. The plurality of data managed by each substrate processing apparatus 120 includes log information of each data.

An analysis device 140 is connected to the substrate processing apparatus 120a1. The analysis device 140 acquires the plurality of data managed by the substrate processing apparatus 120a1, and analyzes the data. While FIG. 1 illustrates the analysis device 140 connected only to the substrate processing apparatus 120a1, the analysis device 140 is connected to each of the substrate processing apparatuses 120a1 to 120a3, 120b1, 120b2, 120c1, and 120c2. Without being limited to this configuration, one analysis device 140 may be connected to one substrate processing apparatus 120, or one analysis device 140 may be connected to two or more substrate processing apparatuses 120.

[Hardware Configuration of Analysis Device]

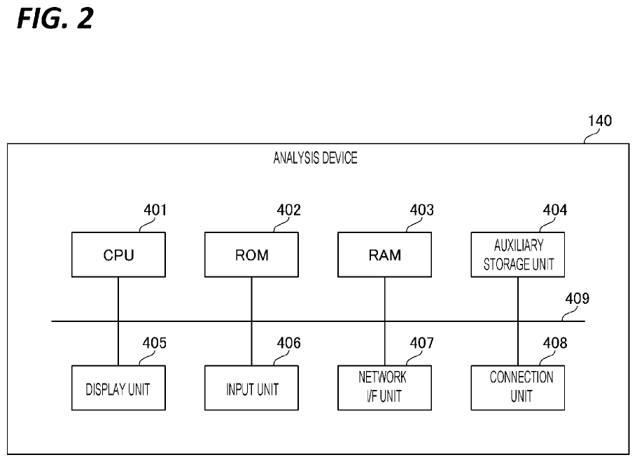

Next, a hardware configuration of the analysis device 140 will be described. FIG. 2 is a view illustrating an example of the hardware configuration of the analysis device 140. As illustrated in FIG. 2, the analysis device 140 includes a central processing unit (CPU) 401, a read only memory (ROM) 402, and a random access memory (RAM) 403. The CPU 401, the ROM 402, and the RAM 403 make up a so-called computer.

The analysis device 140 further includes an auxiliary storage unit 404, a display unit 405, an input unit 406, a network OF (interface) unit 407, and a connection unit 408. The hardware components of the analysis device 140 are connected to each other via a bus 409.

The CPU 401 is a device that executes various programs (e.g., an analysis program to be described later) installed in the auxiliary storage unit 404. The ROM 402 is a nonvolatile memory. The ROM 402 functions as a main storage device that stores various programs or data needed to cause the CPU 401 to execute the various programs installed in the auxiliary storage unit 404. Specifically, the ROM 402 stores, for example, boot programs such as a basic input/output system (BIOS) and an extensible firmware interface (EFI).

The RAM 403 is a volatile memory such as a dynamic random access memory (DRAM) or a static random access memory (SRAM). The RAM 403 functions as a main storage device that provides a work area where the various programs installed in the auxiliary storage unit 404 are developed when the CPU 401 executes the programs.

The auxiliary storage unit 404 is an auxiliary storage device that stores various programs, or information used when the various programs are executed. A data storage unit to be described later is implemented by the auxiliary storage unit 404.

The display unit 405 is a display device that displays various screens (e.g., a data selection screen to be described later). The input unit 406 is an input device allowing an operator to input various instructions to the analysis device 140.

The network OF unit 407 is a communication device that connects to an external network (not illustrated). The connection unit 408 is a connection device that connects to the substrate processing apparatus 120a1.

[Functional Configuration of Analysis Device]

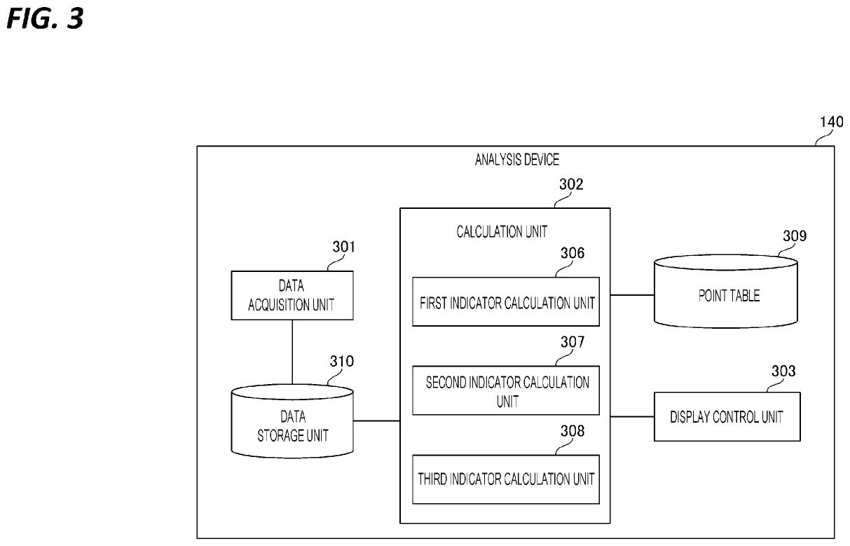

Next, a functional configuration of the analysis device 140 will be described with reference to FIG. 3. FIG. 3 is a view illustrating an example of the functional configuration of the analysis device 140. Hereinafter, descriptions will be made with an example where the analysis device 140 performs a data analysis using the plurality of data managed by the substrate processing apparatus 120a1. The data analysis may be identically performed for a plurality of data managed by each substrate processing apparatus 120a other than the substrate processing apparatus 120a1. As described above, the analysis program is installed in the analysis device 140, and by executing the analysis program, the analysis device 140 functions as a data acquisition unit 301, a calculation unit 302, and a display control unit 303.

The data acquisition unit 301 continuously acquires specific data from the plurality of data managed by the substrate processing apparatus 120a1, and stores the acquired specific data in the data storage unit 310. The data storage unit 310 stores the specific data managed by the substrate processing apparatus 120a1.

The specific data acquired by the data acquisition unit 301 include the number of selections and selection date/time of each data selected for indicating the status of the substrate processing apparatus 120a1, and a set of data and the number of selections thereof when two or more data are selected.

The data managed by the substrate processing apparatus 120 include, for example, various data (parameters) for a substrate processing performed in the substrate processing apparatus 120. Among the various data, the process condition data are set values, such as process conditions, preset in a recipe. The process condition data may include, for example, a heater power, a heater temperature, a pressure, a gas type, a gas flow rate, an RF power, a valve opening degree, a time for each step of a process, and a temperature rise and/or fall rate. Among the various data, the sensor data are detection values of sensors equipped in the substrate processing apparatus 120. The sensor data may include detection values of, for example, a temperature sensor, a pressure sensor, and a plasma emission monitor. Among the various data, the data indicating process results are measurement values indicating process results such as film formation characteristics or etching characteristics. The data indicating process results may include, for example, a film formation rate, a refractive indicator (RI), an etching rate, and a CD value of an etched recess.

The data managed by the substrate processing apparatus 120 may further include, for example, a position of forks or arms of a substrate transfer device, a torque of pins lifting a substrate, a size of a substrate (wafer), a substrate type, the number of substrates, a type of film on a substrate, and a type of a substrate processing apparatus. These data may be acquired by the data acquisition unit 301 and stored in the data storage unit 310.

The calculation unit 302 calculates specific indicators indicating the status of the substrate processing apparatus 120a1, by using at least one of the specific data acquired from the data managed by the substrate processing apparatus 120a1.

The calculation unit 302 includes a first indicator calculation unit 306, a second indicator calculation unit 307, and a third indicator calculation unit 308. The calculation unit 302 executes a process including at least one of a first indicator calculation process executed by the first indicator calculation unit 306, a second indicator calculation process executed by the second indicator calculation unit 307, and a third indicator calculation process executed by the third indicator calculation unit 308. Various points and others calculated by the calculation unit 302 are stored in a point table 309.

(First Indicator: Number-of-Selections Point)

The first indicator calculation unit 306 calculates a first indicator indicating a selection frequency of each data, based on the number of selections of each data selected from the specific data. In this embodiment, the first indicator calculation unit 306 calculates a number-of-selections point (number-of-selections pt) from Formula (1), as an example of the first indicator. However, the present disclosure is not limited thereto.

Number-of-selections point=(the number of selections/maximum value of the number of selections)×100 (1)

The number of selections of each specific data is calculated, and the largest value thereof is taken as the maximum value of the number of selections. Then, assuming that the number of selections of data with the largest value is 100, the ratio of the number of selections of each data is calculated as the number-of-selections point from Formula (1).

For example, when the specific data are sensor values managed by the substrate processing apparatus 120a1 from all sensors such as a temperature sensor and a pressure sensor, the maximum value of the number of selections is the number of selections of a sensor that has been the most frequently selected among all of the sensors.

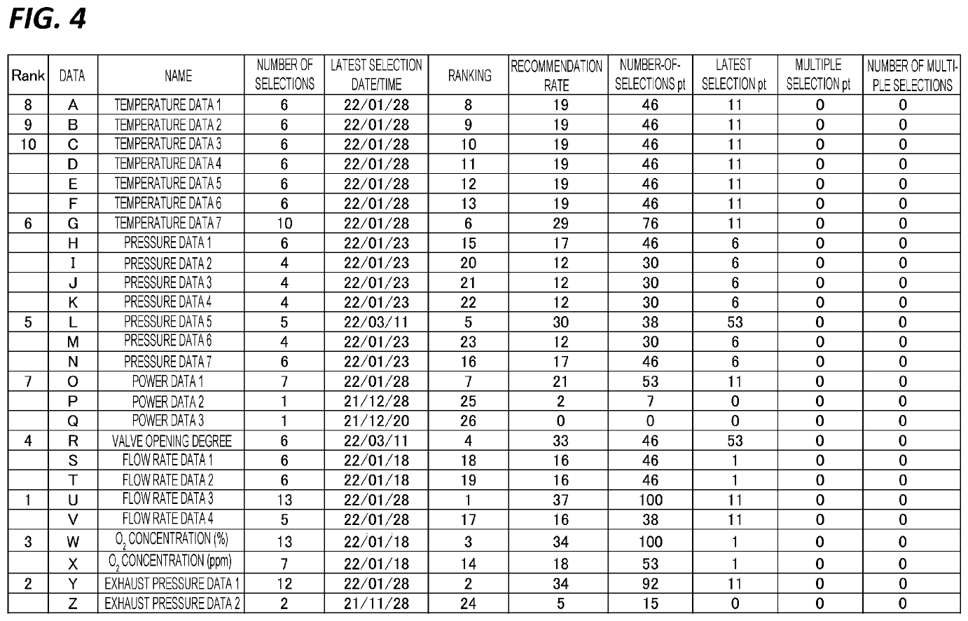

FIG. 4 is an example of the point table 309 according to an embodiment. The item “Data” represents the specific data acquired by the data acquisition unit 301 from the plurality of data managed by the substrate processing apparatus 120a1. In this embodiment, the “Data” item of the point table 309 stores specific data A to Z acquired by the data acquisition unit 301.

The point table 309 stores the “Number of Selections” for each data of the “Data” item, which has been selected for indicating the status of the substrate processing apparatus 120a1. The value of the “Number of Selections” is obtained by adding “1” to the number of selections of each data of the “Data” item every time the data is selected

In this embodiment, the maximum value of the “Number of Selections” in the point table 309 is “13” of data “U” and “W” of the “Data.” Thus, the first indicator calculation unit 306 inserts “13” as the maximum value of the number of selections and the number of selections of each data into Formula (1), to calculate the number-of-selections point.

The first indicator calculation unit 306 stores the calculated number-of-selections point in the item “Number of Selections pt.” The number-of-selections point is an indicator indicating the frequency of selection of each data in “Data.” Considering that data selected very often in the past will also highly likely be selected in the future, it is understood that data with the large number of selections has a high number-of-selections point and is more likely to be selected.

The method of calculating the first indicator is not limited as long as it may obtain a value indicating the frequency that each data is selected. For example, the number of selections itself for each data may be used as the number-of-selections point. Further, the number-of-selections point may be a value obtained by multiplying the number of selections point calculated using Formula (1) by a preset weighting coefficient.

(Second Indicator: Latest Selection Point)

The point table 309 of FIG. 4 includes the item “Latest Selection Date/Time” storing the latest date/time when each data of the “Data” item is selected. Each time the data is selected, its date/time in the “Latest Selection Date/Time” item is updated to the latest selection date/time.

Based on the latest selection date/time of each data selected from the specific data, the second indicator calculation unit 307 calculates a second indicator indicating the latest selection frequency of each data. While the second indicator calculation unit 307 calculates the latest selection point (latest selection pt) from Formula (2) as an example of the second indicator, the present disclosure is not limited thereto.

Latest selection point=100−(today-latest selection date) (2)

The second indicator calculation unit 307 subtracts 1 from 100 each time one day elapses after the latest selection date/time of each “Data,” and takes the obtained value as the latest selection point. For example, when one day elapses from the latest selection date, the expression (today-latest selection date) is “1,” and the latest selection point is “99.” For data that has not been selected for 100 days or more since the latest selection date, the latest selection point is uniformly “0.” That is, as the latest selection date/time of “Data” is old, the latest selection point of the data is close to “0.” Accordingly, the latest selection point for data that has not been selected for a long time is low.

The second indicator calculation unit 307 stores the calculated latest selection point in the item “Latest Selection pt” of the point table 309. The latest selection point is an indicator indicating the frequency as to how often each data of “Data” is selected in a recent period of time. Considering that more recently selected data will also highly likely be selected in the near future, it is understood that data with the latest selection date close to the present time (today) has a large latest selection point and is more likely to be selected.

The method of calculating the second indicator is not limited as long as it may obtain a value indicating the latest selection frequency of each data. For example, the latest selection point may be a value obtained by multiplying the latest selection point calculated using Formula (2) by a preset weighting coefficient.

(Third Indicator: Multiple Selection Point)

When multiple data are selected from the specific data, the third indicator calculation unit 308 calculates a third indicator indicating a selection frequency of each set of data based on the number of selections of each set of data among the selected multiple data. The third indicator calculation unit 308 may calculate a multiple selection point (multiple selection pt) from Formula (3) as an example of the third indicator. However, the method of calculating the third indicator is not limited to the calculation by Formula (3) as long as it may obtain a value indicating a selection frequency per multiple data (data set) when multiple data are selected from the specific data.

Multiple selection point=(number of multiple selections/maximum value of number of multiple selections)×100 (3)

When multiple data are selected from the specific data, the number of multiple selections of each data set is calculated, and the largest value thereof is taken as the maximum value of the number of multiple selections. Then, assuming that the number of multiple selections of data with the largest value is 100, the ratio of the number of multiple selections of each data set is calculated as the multiple selection point from Formula (3).

When data sets each including two data are created from currently selected multiple data, the number of multiple selections indicates the number of times that both data in each set are selected. The method of calculating the number of multiple selections will be described, for example, assuming that three data A, B, and C are selected from the specific data. In this case, three data sets (data A, data B), (data A, data C), and (data B, data C) are created from the selected multiple data.

The third indicator calculation unit 308 adds “1” to the number of multiple selections of the set (data A, data B) that includes data B selected together when data A is selected, and adds “1” to the number of multiple selections of the set (data A, data C) that includes data C selected together with data A.

Further, the third indicator calculation unit 308 adds “1” to the number of multiple selections of the set (data A, data B) that includes data A selected together when data B is selected, and adds “1” to the number of multiple selections of the set (data B, data C) that includes data C selected together when data B.

Further, the third indicator calculation unit 308 adds “1” to the number of multiple selections of the set (data A, data C) that includes data A selected together when data C is selected, and adds “1” to the number of multiple selections of the set (data B, data C) that includes data B selected together with data C.

As a result, “2” is added to the number of multiple selections of each data set (data A, data B), (data A, data C), or (data B, data C). As for the data sets created from the selected multiple data, (data A, data B) and (data B, data A) may be created as different sets, (data A, data C) and (data C, data A) may be created as different sets, and (data B, data C) and (data C, data B) may be created as different sets. In this case, for example, “1” may be added to the number of multiple selections for each of the six data sets (data A, data B), (data B, data A), (data A, data C), (data C, data A), (data B, data C), and (data C, data B). The method of calculating the number of multiple selections of each data set is not limited to the method described above, and other calculation methods may be applied.

The point table 309 of FIG. 4 stores data “A” to “Z” in the “Data” item. For example, when data “A” is selected, the third indicator calculation unit 308 counts up the number of times that each of “B” to “Z” is selected together with “A,” in the item “Number of Multiple Selections” corresponding to each of “B” to “Z.” Accordingly, among data “B” to “Z,” data that has never been selected together with “A” has 0 or a blank field in the “Number of Multiple Selections” item.

Although not illustrated in the point table 309 of FIG. 4, for example, when the maximum value of the number of multiple selections is “6,” and the number of multiple selections of data “B” selected together with data “A” is “6,” the third indicator calculation unit 308 obtains 100 as the multiple selection point from Formula (3). Then, “100” is stored in the item “Multiple Selection pt” for data “B” in association with data “A” making up a set with data “B.” This calculation is identically performed for the other data selected together with data “A,” and the obtained multiple selection point is stored in the “Multiple Selection pt” item for each data selected together with data “A,” in association with data “A” making up a set with each selected data.

The multiple selection point is an indicator indicating the frequency that data of each “Data” set are selected together. Considering that data selected very often together with certain data will highly likely be selected together again in the next time, it is understood that a data set with the large number of multiple selections has a large multiple selection point and is more likely to be selected.

The method of calculating the third indicator is not limited as long as it may obtain a value indicating the frequency that data of each data set are selected together. For example, the number of multiple selections itself for each data set may be the multiple selection point. Further, the multiple selection point may be a value obtained by multiplying the multiple selection point calculated using Formula (3) by a preset weighting coefficient.

The display control unit 303 takes at least one of the calculated first, second, and third indicators as a specific indicator, and displays selection candidate data highly likely to be selected for indicating the status of the substrate processing apparatus 120a1, based on the specific indicator.

In the substrate processing apparatus 120, there are over 1,000 data such as sensor detection values and set values. In a case where a process evaluation is conducted or problems occur on each substrate processing performed in the substrate processing apparatus 120, a specific data may be mostly selected from the more than 1,000 data, and the selected specific data is traced to display, for example, a waveform thereof. For example, data of a temperature sensor may be selected from the more than 1,000 data, to display and check a waveform of the temperature. As another example, gas data, pressure data, and exhaust valve data may be selected from the more than 1,000 data, to display and check the state of each selected data in the waveform. In particular, when a problem occurs, it is necessary to identify appropriate data in order to quickly solve the problem.

However, it is not easy to identify data to be selected from the more than 1,000 data for the purpose of, for example, solving a problem. For selecting desired data, it is necessary to grasp the classification or category to which the data belongs. However, for example, even when data are displayed in the hierarchical structure, it is difficult to systematically grasp the level to which each data belongs. Due to enormous data items to be selected, there is a difficulty in identifying all data, and it takes time to select data. While a word search may be performed to select data, in this case, it is necessary to know a correct name of data desired to be selected.

Further, when performing a data analysis, multiple relevant data may be selected. For example, data of a plurality of sensors in the same gas line system may be selected. However, multiple data desired to be selected may belong to different categories, and in this case, it also takes time to collectively search for the multiple data.

Meanwhile, the selection frequency of data selected by a user is not uniform depending on data. Further, when multiple data are selected, the selection frequency of the multiple data is not also uniform. Therefore, referring to the user's past data selection history, data more likely to be selected may be preferentially displayed on a screen, so that the user may easily select data desired to be displayed.

In the present embodiment, for example, the display control unit 303 takes at least one of the calculated first, second, and third indicators as a specific indicator, and extracts and displays selection candidate data based on the specific indicator. This makes it possible to propose, to the user, data expected to highly likely be selected as selection candidate data.

For example, the display control unit 303 may take the average value of the calculated first, second, and third indicators as a specific indicator, and display selection candidate data based on the specific indicator. Further, the display control unit 303 may take a value obtained by multiplying the average value of the calculated first, second, and third indicators by a weighting coefficient as a specific indicator, and display selection candidate data based on the specific indicator.

The display control unit 303 may calculate the priority of the selection candidate data from the plurality of data managed by the substrate processing apparatus 120a1 based on the calculated specific indicator, and display the selection candidate data in a descending order of the priority. For example, the display control unit 303 stores the average value of the calculated first, second, and third indicators in the item “Recommendation Rate” of the point table 309. Then, the display control unit 303 may rank the data from highest to lowest of the “Recommendation Rate,” and display top ranked data (e.g., up to ten) as selection candidate data. When the “Recommendation Rate” is the same value, data A to Z of the point table 30 may be ranked in the alphabetical order or a reverse order.

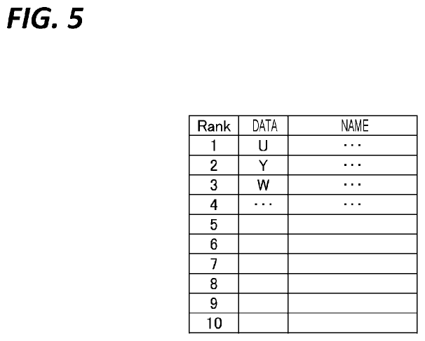

FIG. 5 illustrates an example of the display of selection candidate data. As illustrated in FIG. 5, selection candidate data may be displayed in a rank order from highest to lowest. In FIG. 5, data “U” and its data name are displayed as selection candidate data of the first rank, data “Y” and “W” and their data names are displayed as selection candidate data of the second and third ranks, respectively, and the other selection candidate data and their data names are displayed in an order. The name of each data is stored in the item “Name” of the point table 309.

The selection candidate data exclude already selected data. The display control unit 303 stores the ranks in the item “Ranking” of the point table 309, and also stores top ranks (e.g., up to ten) in the item “Rank.” The point table 309 may store either one of the “Ranking” and “Rank” items.

[Selection Supporting Method]

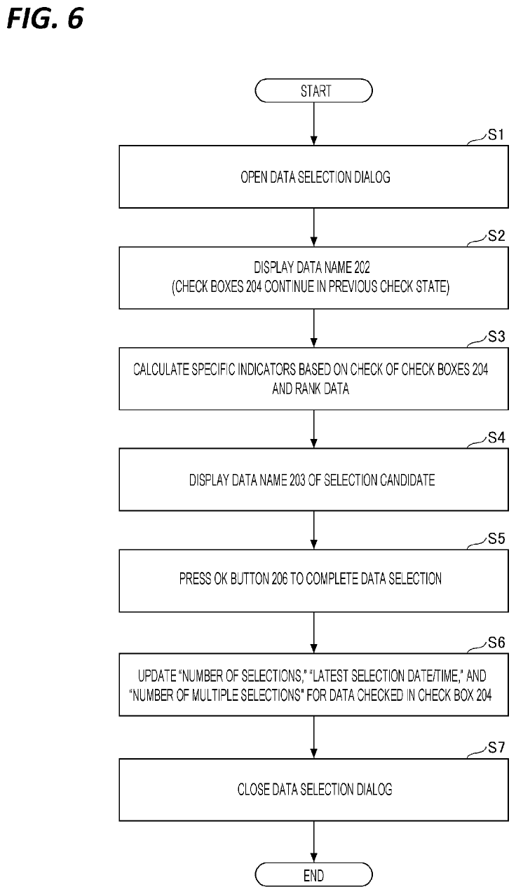

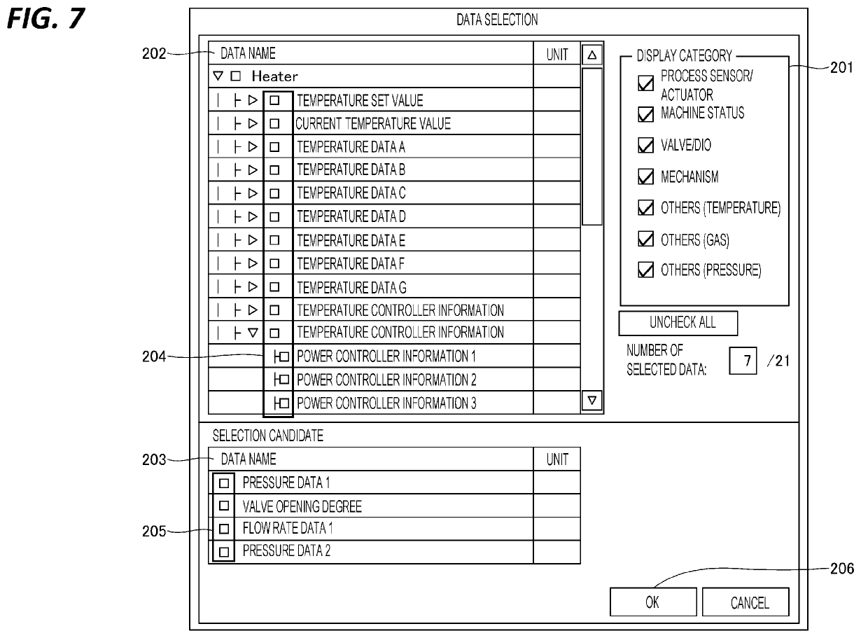

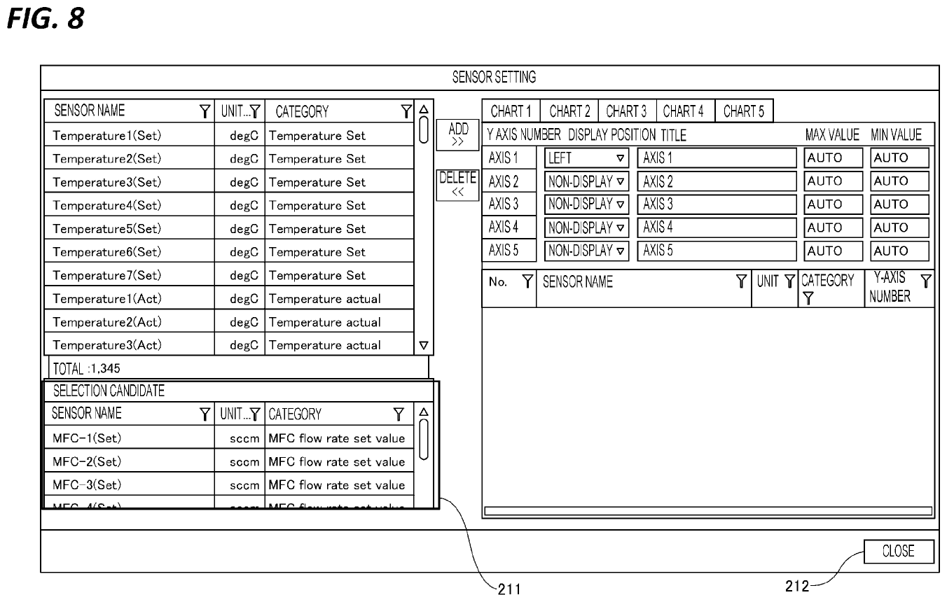

Next, a selection supporting method according to an embodiment will be described with reference to FIGS. 6 to 8. FIG. 6 is a flowchart illustrating an example of a selection control process by the analysis device 140. FIG. 7 is an example of a selection screen for the plurality of data managed by the substrate processing apparatus 120a1. FIG. 8 is an example of a selection screen (remote screen) for the plurality of data managed by the substrate processing apparatus 120a1.

The selection supporting method illustrated in FIG. 6 is performed in the manner that the analysis device 140 performs an analysis based on the check state of check boxes (e.g., 204 in FIG. 7) appearing on the screen of a data selection dialog for the data selection (see, e.g., FIGS. 7 and 8). Additionally, the selection state of categories of first and second levels and data of a third level displayed in the data selection dialog is the same as the selection state of the categories and data displayed in the previous data selection dialog. By using the data selection dialog illustrated as an example in FIG. 7, the user may select some data for indicating the status of the substrate processing apparatus 120a1.

The data selection dialog of FIG. 7 is a display screen that displays information about selected specific data and allows the user to select specific data from the displayed data. The data selection dialog has a display-category display column 201, a data name display column 202, and a selection candidate (data) display column 203. In the data name display column 202, data (items) are displayed hierarchically in a tree shape for each subcategory included in a master category checked in a check box of the display-category display column 201. In the example of FIG. 7, the data name display column 202 displays “Heater” as an example of the subcategory, and further displays data belonging to the subcategory (e.g., a temperature set value, a current temperature value . . . ) in a tree shape originated from “Heater.” That is, the data selection dialog displays the plurality of data managed by the substrate processing apparatus 120a1 in three levels consisting of the first level for a master category, the second level for a subcategory, and the third level for data. Accordingly, by checking a check box of the display-category display column 201, a master category may be selected, and subcategories and data belonging to the selected master category are displayed in the data name display column 202. In this manner, the display switches. The method of displaying data in the data selection dialog is not limited thereto.

The user checks each of the check boxes 204 corresponding to the data of the third level. In this way, the user may select as many data as the number of checked check boxes 204. The method of selecting data is not limited thereto, and for example, the check box of the subcategory of the second level may be checked, thereby selecting all of the data of the lower level (the third level) belonging to the subcategory.

When the selection supporting method of FIG. 6 is started, the display control unit 303 opens the data selection dialog in step S1 of FIG. 6. In step S2, the display control unit 303 displays the data name column 202 (see, e.g., FIG. 7). At this time, the check boxes 204 continue in the previous check state.

Next, in step S3, the calculation unit 302 calculates specific indicators based on the check of the check boxes 204. Then, data ranking is performed based on the specific indicators. At this time, the data ranking excludes the data having the data names checked in the check boxes 204. This is because data already checked in the check boxes 204 do not need to be displayed as selection candidates. Further, when multiple data are checked, it is determined which set is subjected to the calculation of the multiple selection point of the third indicator. When calculating the specific indicators, the first indicator calculation unit 306 adds “1” to the “Number of Selections” of each selected (checked) data. For each selected data, the second indicator calculation unit 307 acquires date/time when the data is selected. The “Number of Selections” and the “Latest Selection Date/Time” in the point table 309 (see, e.g., FIG. 4) are updated in step S6. When multiple data are selected, the third indicator calculation unit 308 adds “1” to the “Number of Multiple Selections” of the selected data set. In this case as well, the “Number of Multiple Selections” of the point table 309 (see, e.g., FIG. 4) is updated in step S6.

For each data of the “Data” item of the point table 309, the calculation unit 302 calculates the average value of the values of the “Number of Selection pt,” “Latest Selection pt,” and “Multiple Selection pt” items, and stores the calculated average value in the “Recommendation Rate” item. The display control unit 303 ranks the values of the “Recommendation Rate” item from highest to lowest, and updates the “Ranking” item. The display control unit 303 stores top ranks (e.g., up to ten) in the “Rank” item.

Next, in step S4, the display control unit 303 displays data names in an order from “Data” ranked first in “Rank,” in the selection candidate data display column 203. As a result, update is made on the data names of the selection candidate data displayed in the selection candidate data display column 203 of the data selection dialog of FIG. 7. When the user checks one of the check boxes 205 desired to be displayed from the selection candidate data display column 203, the display control unit 303 automatically checks the check boxes 204 of the data identical to the checked selection candidate data and displayed in the data name display column 202.

Next, in step S5, when the user presses an “OK” button 206, the display control unit 303 completes the data selection.

Next, in step S6, the display control unit 303 updates the “Number of Selections,” the “Latest Selection Date/Time,” the “Number of Selections pt,” and the “Latest Selection pt” of the point table 309 for each data checked in the check boxes 204. Further, when multiple data are selected, the display control unit 303 updates the “Number of Multiple Selections” and the “Multiple Selection pt.”

Next, in step S7, the display control unit 303 closes the screen of the data selection dialog, and terminates the process.

After the process is terminated, the analysis device 140 may display the log information of the selected data that has been stored in the data storage unit 310. The log information of the selected data may be displayed on the screen after the screen of the data selection dialog is closed. The log information of the selected data may be displayed in a graph such as a waveform, by tracing the past state of the selected specific data. Information obtained by tracing the selected specific data at all times may be displayed, or a process log details screen may be displayed. Further, the analysis device 140 may display information of at least one of the items “Number of Selections,” “Latest Selection Date/Time,” “Number of Multiple Selections,” “Number of Selections pt,” “Latest Selection pt,” and “Multiple Selection pt” of the point table 309.

As represented in step S3, the calculation of each indicator, the determination of ranks, and the update of selection candidate data are performed after the check boxes 204 are checked or unchecked. The first indicator calculation unit 306 calculates the number of selections point. The second indicator calculation unit 307 calculates the latest selection point. The third indicator calculation unit 308 calculates the multiple selection point. In the point table 309, the “Number of Selections pt” is updated to the calculated value of the number of selections point, the “Latest Selection pt” is updated to the calculated latest selection point value, and the “Multiple Selection pt” is updated to the calculated multiple selection point value.

The data selection dialog illustrated in FIG. 7 may be displayed on the screen of the control device 121a1 that controls the substrate processing apparatus 120a1 of FIG. 1 and operated by the user. Without being limited thereto, the data selection dialog may be displayed on a screen of any information processing apparatus as long as the apparatus may be used by the user.

For example, FIG. 8 illustrates an example of a data selection dialog displayed on an information processing apparatus capable of remotely controlling the substrate processing apparatus 120a1 and/or the control device 121a1. The information processing apparatus that displays the data selection dialog of FIG. 8 may be the analysis device 140, the host device 110a, or the server device 150. The information processing apparatus may be another information processing apparatus that may connect to the substrate processing apparatus 120a1 and/or the control device 121a1.

The data selection dialog of the information processing apparatus in FIG. 8 also includes a selection candidate data display column 211. Thus, it is possible to propose, to the user, data expected to highly likely be selected as selection candidate data, and the user may easily select data desired to be displayed.

[Selection Supporting Method]

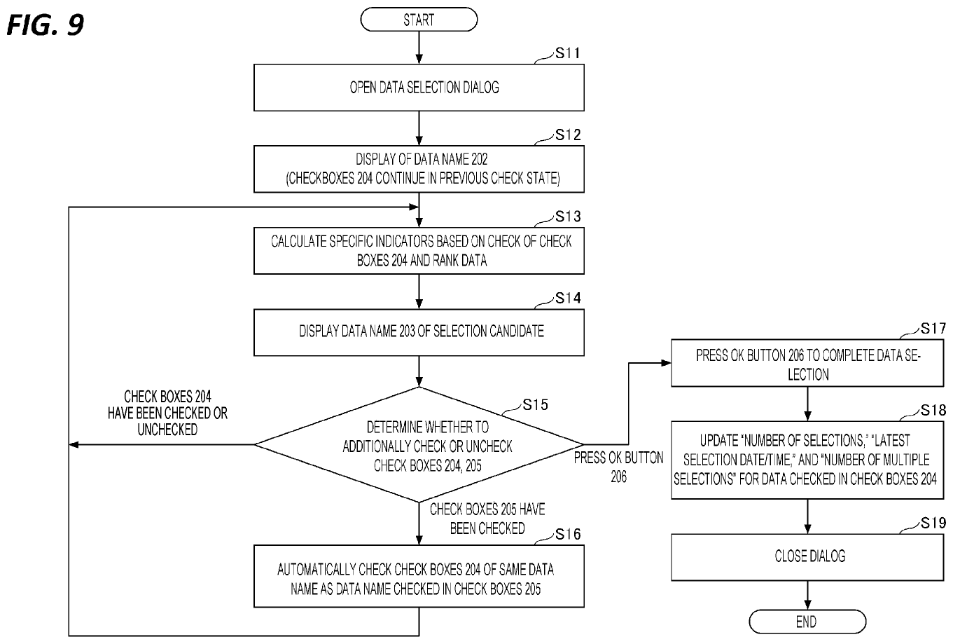

Next, descriptions will be made on another example of the selection supporting method according to an embodiment (where the selection of selection candidate data is repeated), with reference to FIG. 9. FIG. 9 is a flowchart illustrating another example of the selection control process performed by the analysis device 140.

When the selection supporting method illustrated in FIG. 9 is started, the display control unit 303 opens the data selection dialog in step S11 of FIG. 9. In step S12, the display control unit 303 displays the data names 202 (see, e.g., FIG. 7). At this time, the check boxes 204 continue in the previous check state.

Next, in step S13, the calculation unit 302 calculates specific indicators based on the check of the check boxes 204. Then, data ranking is performed based on the specific indicators. At this time, the data ranking excludes the data having the data names checked in the check boxes 204. Further, when multiple data are checked, it is determined which set is subjected to the calculation of the multiple selection point of the third indicator. When calculating the specific indicators, the first indicator calculation unit 306 adds “1” to the “Number of Selections” of each selected (checked) data. For each selected data, the second indicator calculation unit 307 acquires date/time when the data is selected. The “Number of Selections” and the “Latest Selection Date/Time” in the point table 309 (see, e.g., FIG. 4) are updated in step S18. When multiple data are selected, the third indicator calculation unit 308 adds “1” to the “Number of Multiple Selections” of the selected data set. In this case as well, the “Number of Multiple Selections” of the point table 309 (see, e.g., FIG. 4) is updated in step S18.

For each data of the “Data” item of the point table 309, the calculation unit 302 calculates the average value of the values of the items “Number of Selections pt,” “Latest Selection pt,” and “Multiple Selection pt,” and stores the calculated average value in the “Recommendation Rate” item. The display control unit 303 ranks the values of the “Recommendation Rate” item from highest to lowest, and updates the “Ranking” item. The display control unit 303 stores top ranks (e.g., up to ten) in the “Rank” item.

Next, in step S14, the display control unit 303 displays data names in an order from “Data” ranked first in “Rank,” in the selection candidate data display column 203. As a result, update is made on the data names of the selection candidate data displayed in the selection candidate data display column 203 of the data selection dialog of FIG. 7.

Next, in step S15, the display control unit 303 determines whether to additionally check or uncheck the check boxes 204 or 205.

When it is determined in step S15 that the check boxes 204 have been checked or unchecked, the calculation unit 302 returns to step S13 and calculates specific indicators based on the check of the check boxes 204. Then, in step S14, the display control unit 303 displays data names in an order from “Data” ranked first in “Rank,” in the selection candidate data display column 203. As a result, update is made on the data names of the selection candidate data displayed in the selection candidate data display column 203 of the data selection dialog of FIG. 7.

When the user checks one of the check boxes 205 displayed in the selection candidate data display column 203, it is determined that the check boxes 205 for the selection candidate data have been checked in step S15, and step S16 proceeds. In step S16, the display control unit 303 automatically checks the check boxes 204 of the data names identical to the checked selection candidate data and displayed in the data name display column 202. Then, returning to step S13, the calculation unit 302 calculates specific indicators based on the check of the check boxes 204. Then, in step S14, the display control unit 303 displays data names in an order from “Data” ranked first in “Rank,” in the selection candidate data display column 203. As a result, update is made on the data names of the selection candidate data displayed in the selection candidate data display column 203 of the data selection dialog of FIG. 7.

In step S15, the user confirms the state where the check boxes 204 desired to be selected are entirely checked, and presses the “OK” button 206. Accordingly, step S17 proceeds, and the display control unit 303 completes the data selection in response to the pressing of the “OK” button 206.

Next, in step S18, the display control unit 303 updates the “Number of Selections,” the “Latest Selection Date/Time,” the “Number of Selections pt,” and the “Latest Selection pt” of the point table 309 for each selected data. Further, when multiple data are selected, the “Number of Multiple Selections” and the “Multiple Selection pt” are updated.

Next, in step S19, the display control unit 303 closes the screen of the data selection dialog, and terminates the process.

In the example of the selection supporting method of FIG. 9, the calculation unit 302 executes the process of calculating specific indicators indicating the status of the substrate processing apparatus 120a1, each time selection candidate data is selected. Then, based on the specific indicators, the display control unit 303 displays selection candidate data from the plurality of data. After the data selection dialog is closed, the log information of data selected from the data selection dialog may be displayed. As a result, the status of the substrate processing apparatus may easily be displayed in relation to the selected data.

As described above, according to the information processing apparatus and the selection supporting method of the present embodiment, appropriate selection candidate data may be proposed to the user, which facilitates the selection of data desired to be displayed from the plurality of data managed by the substrate processing apparatus. The log information of the selected data is traced and displayed in a graph or the like, so that the user may check the status of the substrate processing apparatus in a shorter time.

The information processing apparatus and the selection supporting method according to the embodiments described herein are examples, and should not be construed as being limited, in all aspects. The embodiments may be modified and improved in various forms without departing from the scope and gist of the appended claims. The matters described in the plurality of embodiments herein may adopt other configurations or may be combined within the scope that does not cause any inconsistency.

For example, in the selection supporting method described above, the plurality of data managed by the substrate processing apparatus 120a1 are stored in the data storage unit 310, and specific indicators are calculated from, for example, the number of selections for the plurality of data stored in the data storage unit 310. Then, selection candidate data are displayed based on the specific indicators.

Without being limited thereto, specific indicators may be calculated from, for example, the number of selections for the plurality of data managed by a plurality of or all substrate processing apparatuses 120, and selection candidate data may be displayed based on the specific indicators. Further, when the substrate processing apparatus 120a1 manages a plurality of data, specific indicators may be calculated from the plurality of data for each user who uses the substrate processing apparatus 120.

When calculating specific indicators, the calculations of the number of selections point, the latest selection point, and the multiple selection point are examples, and other methods may be used. For example, the number of selections point and the multiple selection point may not be calculated as the percentages from Formulas (1) and (3). Further, the latest selection point may not be calculated by subtracting the difference between today and the latest selection date from 100 as in Formula (2).

For example, the analysis device 140 may have a learning function to learn a weighting coefficient of each data. For example, when the analysis device 140 learns weighting coefficients of the number of selections point, the latest selection point, and the multiple selection point, the calculation unit 302 may calculate more appropriate specific indicators. Further, by the learning function of the analysis device 140, constants of Formulas (1) to (3) or these formulas themselves may be updated to more appropriate values or formulas.

Selection candidate data learned by one substrate processing apparatus 120 may be set as the initial values of selection candidate data to be displayed on another substrate processing apparatus 120.

Additionally, the substrate processing system 100 of FIG. 1 is an example, and it is obvious that there are various examples of system configurations depending on application or a purpose. The substrate processing apparatus of the present disclosure may be applied to any of a single-wafer apparatus that processes substrates one by one, and a batch or semi-batch apparatus that collectively processes a plurality of substrates.

The substrate processing performed by the substrate processing apparatus of the present disclosure includes, for example, a film formation and an etching. The substrate processing apparatus of the present disclosure is not limited to an apparatus that processes a substrate using plasma, but may be an apparatus that processes a substrate without using plasma.

The substrate processing apparatus of the present disclosure may be applied to any type of apparatus such as an atomic layer deposition (ALD) apparatus, a capacitively coupled plasma (CCP) apparatus, an inductively coupled plasma (ICP) apparatus, a radial line slot antenna (RLSA) apparatus, an electron cyclotron resonance plasma (ECR) apparatus, and a helicon wave plasma (HWP) apparatus.

According to an aspect, data desired to be displayed may easily be selected from a plurality of data managed by a substrate processing apparatus.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
a data acquisition circuitry configured to acquire specific data from a plurality of data managed by a substrate processing apparatus, the specific data including a number of selections and selection date/time for each data selected for indicating a status of the substrate processing apparatus, and a set of data and a number of selections of the set when multiple data are selected;
a calculation circuitry configured to calculate a specific indicator indicating the status of the substrate processing apparatus by using at least one of the specific data; and
a display control circuitry configured to display selection candidate data extracted from the plurality of data based on the specific indicator calculated by the calculation circuitry,
wherein the calculation circuitry executes at least one of following processes including,
based on a number of selections of each data selected from the specific data, calculating a first indicator indicating a selection frequency of the data,
based on selection date/time of each data selected from the specific data, calculating a second indicator indicating a latest selection frequency of the data, and
based on a number of selections for each set of data among multiple data selected from the specific data, calculating a third indicator indicating a selection frequency for each set of the data, and
wherein the display control circuitry takes at least one of the first, second, and third indicators calculated by the calculation circuitry as the specific indicator, and displays the selection candidate data based on the specific indicator.

2. The information processing apparatus according to claim 1, wherein the display control circuitry calculates a priority of the selection candidate data based on the specific indicator, and displays the selection candidate data according to the priority.

3. The information processing apparatus according to claim 1, wherein when the selection candidate data is selected from a data selection screen, the display control circuitry automatically selects the selection candidate data as the data for indicating the status of the substrate processing apparatus.

4. The information processing apparatus according to claim 3, wherein each time the data for indicating the status of the substrate processing apparatus is selected from the data selection screen, the calculation circuitry executes calculating the specific indicator indicating the status of the substrate processing apparatus, and
each time the calculation circuitry executes calculating the specific indicator, the display control circuitry displays the selection candidate data extracted from the plurality of data based on the specific indicator.

5. The information processing apparatus according to claim 3, wherein when the data selection screen is closed, log information of the data selected for indicating the status of the substrate processing apparatus is displayed.

6. The information processing apparatus according to claim 3, wherein the data acquisition circuitry acquires specific data from a plurality of data managed by a plurality of substrate processing apparatuses capable of communicating with each other via a network, the specific data including a number of selections and selection date/time for each data selected for indicating a status of each of the substrate processing apparatuses, and a set of data and a number of selections of the set when multiple data are selected,
the calculation circuitry calculates a specific indicator indicating a status of at least one of the plurality of substrate processing apparatuses by using at least one of the specific data, and
the display control circuitry, based on the calculated specific indicator, displays the selection candidate data extracted from the plurality of data managed by the plurality of substrate processing apparatuses.

7. A selection supporting method comprising:
acquiring specific data from a plurality of data managed by a substrate processing apparatus, the specific data including a number of selections and selection date/time for each data selected for indicating a status of the substrate processing apparatus, and a set of data and a number of selections of the set when multiple data are selected;
calculating a specific indicator indicating the status of the substrate processing apparatus by using at least one of the specific data; and
displaying selection candidate data extracted from the plurality of data based on the specific indicator calculated in the calculating,
wherein the calculating executes at least one of following processes including,
based on a number of selections of each data selected from the specific data, calculating a first indicator indicating a selection frequency of the data,
based on selection date/time of each data selected from the specific data, calculating a second indicator indicating a latest selection frequency of the data, and
based on a number of selections for each set of data among multiple data selected from the specific data, calculating a third indicator indicating a selection frequency for each set of the data, and
wherein the displaying takes at least one of the first, second, and third indicators calculated in the calculating, as the specific indicator, and displays the selection candidate data based on the specific indicator.

8. The selection supporting method according to claim 7, wherein, in the displaying selection candidate data, a priority of the selection candidate data is calculated based on the specific indicator, and the selection candidate data are displayed according to the priority.

9. The selection supporting method according to claim 7, wherein when the selection candidate data is selected from a data selection screen, the selection candidate data are selected automatically as the data for indicating the status of the substrate processing apparatus.

10. The selection supporting method according to claim 9, wherein each time the data for indicating the status of the substrate processing apparatus is selected from the data selection screen, the specific indicator indicating the status of the substrate processing apparatus is calculated, and
each time the specific indicator is calculated, the selection candidate data extracted from the plurality of data are displayed based on the specific indicator.

11. The selection supporting method according to claim 9, wherein when the data selection screen is closed, log information of the data selected for indicating the status of the substrate processing apparatus is displayed.

12. The selection supporting method according to claim 9, wherein the specific data are acquired from a plurality of data managed by a plurality of substrate processing apparatuses capable of communicating with each other via a network, the specific data including a number of selections and selection date/time for each data selected for indicating a status of each of the substrate processing apparatuses, and a set of data and a number of selections of the set when multiple data are selected,
a specific indicator indicating a status of at least one of the plurality of substrate processing apparatuses is calculated by using at least one of the specific data, and
the selection candidate data extracted from the plurality of data managed by the plurality of substrate processing apparatuses are displayed based on the calculated specific indicator.

13. An information processing apparatus comprising:
a memory; and
a processor coupled to the memory and configured to
acquire specific data from a plurality of data managed by a substrate processing apparatus, the specific data including a number of selections and selection date/time for each data selected for indicating a status of the substrate processing apparatus, and a set of data and a number of selections of the set when multiple data are selected;
calculate a specific indicator indicating the status of the substrate processing apparatus by using at least one of the specific data; and
display selection candidate data extracted from the plurality of data based on the specific indicator calculated by the calculation circuitry,
wherein, when the processor calculates a specific indicator indicating the status of the substrate processing apparatus by using at least one of the specific data, the processor is further configured to,
based on a number of selections of each data selected from the specific data, calculate a first indicator indicating a selection frequency of the data,
based on selection date/time of each data selected from the specific data, calculate a second indicator indicating a latest selection frequency of the data, and
based on a number of selections for each set of data among multiple data selected from the specific data, calculate a third indicator indicating a selection frequency for each set of the data, and
wherein the processor takes at least one of the first, second, and third indicators as the specific indicator, and displays the selection candidate data based on the specific indicator.
